(19) United States
(12) Patent Application Publication
(10) Pub. No.: US 2025/0219916 A1
(43) Pub. Date: Jul. 3, 2025

(54) SYSTEM, DEVICES AND METHODS FOR ZERO-TOUCH ENHANCED QUALITY OF EXPERIENCE DATA COLLECTION AND COMMUNICATION

(71) Applicant: eSpace Networks, Inc., Dover, DE (US)

(72) Inventors: Richard Conklin, Cumming, GA (US); William Vaugham, Dover, DE (US); Gustav Karl Larsson, Sunnyvale, CA (US)

(21) Appl. No.: 19/004,410

(22) Filed: Dec. 29, 2024

Related U.S. Application Data
(60) Provisional application No. 63/616,022, filed on Dec. 29, 2023.

(51) Int. Cl. H04L 41/5067; H04L 43/04

(52) U.S. Cl. CPC H04L 41/5067; H04L 43/04

(57) ABSTRACT

A method for collecting and providing QoE data including continually monitoring a network connection to determine a network ID and whether the network ID is associated with a QoE environment; and when the network ID is associated with the QoE environment, communicating an entry into the QoE environment to a data aggregator for the QoE environment, activating the gathering of QoE data, communicating the QoE data to the data aggregator, and stopping the gathering and communication of QoE data when the network ID no longer matches a QoE environment identifier or when designated as inactive. A system for same including a QoE environment, a data aggregator and wireless router(s), and QoE monitor(s), where the QoE monitors can communicate with the data aggregator to obtain an active or inactive status, and if active may automatically begin collecting and communicating QoE data to the data aggregator without user input.

### BACKGROUND

Many environments are unable to utilize wired connectivity due to the nature of those environments, including but not limited to airplanes, ships, trains, trucks, buses, oil rigs, etc. Those endpoints may have access to connectivity that can be variable including satellite (LEO/MEO/GEO), Cellular (LTE/4G/5G), temporary wired connections (such as a fiber connected to a ship while it is in port), or temporary WiFi such as train station WiFi or jetway/airport terminal WiFi. The measurement of the availability of connectivity to the end user and the Quality of Experience (“QoE”) for the end user provides valuable insights to the operators of those environments so those operators may purchase the correct amount of bandwidth, validate user experience, or otherwise ensure that their customers are receiving the QoE that they have either purchased or received for free from the operator.

However, many operators have difficulty measuring that QoE (Quality of Experience) in a vendor neutral manner, where the vendor is a service provider providing a connectivity service including but not limited to LEO, MEO, or GEO Satellite, 4G, 5G, or LTE, etc. Often, the operator must have dedicated computer hardware in the environment (ship, plane, train, etc) where a QoE software agent may run, so the to measure the QoE independently from the vendor.

There are two primary ways that operators currently address this issue. First, operators may run a QoE monitor on hardware that is installed on the platform (airplane, ship, train, etc). Often, that hardware is controlled by a connectivity vendor, for example, the provider of Satellite connectivity. In those instances, the operator (for example an airline) requires the cooperation of the connectivity vendor to gain access to the vendor controlled hardware in order to run the independent QoE measurement software. Frequently, connectivity vendors either do not allow access or they require large fees to do so.

Second, operators may choose a smart-phone application to perform the measurement. These applications require input from the device user (for example a crew member on an aircraft or a ship) to indicate the aircraft number, flight number, ship identification, voyage number or similar. These smartphone devices may move from one aircraft to another or from one ship to another. Typically, the employee or crew member must enter the details (for example aircraft tail number and flight number) and start the test. To end the QoE measurement, the employee or crew member must stop the test. In addition to interrupting the employees' other duties, these steps create the potential for errors in the environment, and those errors may invalidate the QoE measurement or cause it to not run at all.

Additionally, the current mobile solutions do not detect when/if multiple instances of the QoE measurement are being performed by two or more different devices for the same test (for example on the same flight). Because each test consumes bandwidth, multiple tests waste bandwidth without providing additional insights. The disclosed concepts overcome these limitations.

### BRIEF DESCRIPTION OF THE DRAWINGS

FIG. 1 illustrates a representation of a QoE environment in accordance with the disclosed concepts.

FIG. 2 illustrates a method for gathering and communicating QoE data in accordance with the disclosed concepts.

FIG. 3 illustrates a method for aggregating QoE data in accordance with the disclosed concepts.

FIG. 4 illustrates a method for mapping a network ID to a QoE environment in accordance with the disclosed concepts.

### DETAILED DESCRIPTION

The following detailed description and the appended drawings describe and illustrate some embodiments for the purpose of enabling one of ordinary skill in the relevant art to make use the invention. As such, the detailed description and illustration of these embodiments are purely illustrative in nature and are in no way intended to limit the scope of the invention, or its protection, in any manner. It should also be understood that the drawings are not necessarily to scale and in certain instances details may have been omitted, which are not necessary for an understanding of the disclosure, such as details of fabrication and assembly. In the accompanying drawings, like numerals represent like components.

The term “network ID” as used herein generally includes both traditional network identifiers, such as a service set identifier (SSID) or a unique network identifier, such as a basic service set identifier (BSSID) or MAC address. Persons of ordinary skill in the art will recognize that implementations of the disclosed concepts can be made utilizing any suitable type of network ID depending on the requirements for the implementation.

In an embodiment, a system may include a QoE environment which may have a data aggregator and one or more wireless routers. The system may further include one or more QoE monitors, where the QoE monitors are capable of connecting to the environment's wireless router to communicate with the data aggregator. Uupon connecting to the QoE environment the QoE monitors may obtain an active or inactive status, and if active may automatically begin collecting and communicating QoE data to the data aggregator without user input.

In certain embodiments the system may further include a first QoE monitor of the one or more QoE monitors that continually monitors a network connection to determine a network ID and whether the network ID is associated with the QoE environment. When the network ID is associated with the QoE environment, the first QoE monitor may communicate its entry into the QoE environment to the data aggregator for the QoE environment, and if designated as active may: activate the gathering of QoE data, communicate the QoE data to the data aggregator; and stop the gathering and communication of QoE data to the data aggregator when the first QoE monitor's network ID no longer matches the QoE environment identifier or when the first QoE monitor is designated as inactive. In certain embodiments the QoE monitors may periodically communicate with the aggregator even when they are not connected to a network associated with a QoE environment.

In certain embodiments, the first QoE monitor continually monitors a network connection may include looking up the network ID on a look-up table to determine whether it is associated with the QoE environment identifier. In certain embodiments, the first QoE monitor continually monitors a network connection may include sending a query to the data aggregator or controller to determine whether the network ID is associated with a QoE environment identifier. In certain embodiments, the first QoE monitor continually monitors a network connection may include using a machine learning or statistical correlation model to determine the QoE environment identifier associated with the network ID.

In certain embodiments, the using a machine learning or statistical correlation model to determine the QoE environment identifier may include communicating with operator systems to obtain departure time and location. In certain embodiments, the using a machine learning or statistical correlation model to determine the QoE environment identifier may include communicating with operator systems to obtain the time and location during transportation. In certain embodiments, the using a machine learning or statistical correlation model to determine the QoE environment identifier may include communicating with operator systems to obtain the time and location at arrival. In certain embodiments, the using a machine learning or statistical correlation model to determine the QoE environment identifier may include communicating with vendor systems to obtain the time and location at departure. In certain embodiments, the using a machine learning or statistical correlation model to determine the QoE environment identifier may include communicating with vendor systems to obtain the time and location at during transportation. In certain embodiments, the using a machine learning or statistical correlation model to determine the QoE environment identifier may include communicating with vendor systems to obtain the time and location at arrival. In certain embodiments, the using a machine learning or statistical correlation model to determine the QoE environment identifier may include communicating with QoE monitors to obtain the time and location at departure. In certain embodiments, the using a machine learning or statistical correlation model to determine the QoE environment identifier may include communicating with QoE monitors to obtain the time and location during transportation. In certain embodiments, the using a machine learning or statistical correlation model to determine the QoE environment identifier may include communicating with QoE monitors to obtain the time and location at arrival. In certain embodiments, the using a machine learning or statistical correlation model to determine the QoE environment identifier may include obtaining a list of potential QoE identifiers. In certain embodiments, the using a machine learning or statistical correlation model to determine the QoE environment identifier may include selecting a probable QoE identifier from the list of potential QoE identifiers. In certain embodiments, the selecting a probable QoE identifier may include generating confidence scores for the potential QoE identifiers. In certain embodiments, the selecting a probable QoE identifier may include evaluating the confidence scores of the potential QoE identifiers. In certain embodiments, the using a machine learning or statistical correlation model to determine the QoE environment identifier may include calculating and assigning a confidence score to one or more of the potential QoE identifiers. In certain embodiments, the calculating and assigning a confidence score may include considering the time and location data at departure. In certain embodiments, the calculating and assigning a confidence score may include considering the time and location data at arrival. In certain embodiments, the calculating and assigning a confidence score may include considering the time and location data during transportation. In certain embodiments, the calculating and assigning a confidence score may include reevaluating and updating the confidence score during transportation based on the time and location data during transportation. In certain embodiments, the calculating and assigning a confidence score may include reevaluating and updating the confidence score during transportation based on the correlation of an observed travel path in comparison to an expected travel path for a potential QoE identifier. In certain embodiments, the calculating and assigning a confidence score may include reevaluating and updating the probable QoE identifier based on the analysis of data gathered after departure. In certain embodiments, the using a machine learning or statistical correlation model to determine the QoE environment identifier may include using time and location data at departure to determine the QoE identifier. In certain embodiments, the using a machine learning or statistical correlation model to determine the QoE environment identifier may include using time and location data during transportation to compare an actual travel path to an expected travel path. In certain embodiments, the using a machine learning or statistical correlation model to determine the QoE environment identifier may include using time and location data at arrival to determine the QoE identifier.

In certain embodiments, the first QoE monitor stops the gathering and communication of QoE data may include receiving an instruction from the data aggregator to become inactive. In certain embodiments, the first QoE monitor stops the gathering and communication of QoE data may include sending a message to the data aggregator to remove the first QoE monitor from a QoE environment identifier group. In certain embodiments, the first QoE monitor communicates its entry into the QoE environment to the data aggregator may include communicating a request to join a QoE environment identifier group to the data aggregator.

In certain embodiments, the first QoE monitor communicates its entry into the QoE environment to the data aggregator may include sending a request to the data aggregator to become active, and waiting for a confirmation before activating the gathering of QoE data.

In certain embodiments, the first QoE monitor activates the gathering the QoE data may include gathering QoE data for the data aggregator. In certain embodiments, the gathering the QoE data for the data aggregator may include running QoE data tests.

In certain embodiments, the first QoE monitor communicates the QoE data to the data aggregator may include communicating test results to the data aggregator. In certain embodiments, the first QoE monitor communicating the QoE data to the data aggregator may include communicating updated QoE monitor parameters to the data aggregator. In certain embodiments, the QoE monitor parameters comprise a first parameter selected from the group consisting of battery life, location, software version, monitor app version, operating system version, and hardware model.

In certain embodiments, the data aggregator may maintain a QoE environment identifier group comprising a list of QoE monitors that are located within the QoE environment. The data aggregator may further determine which QoE monitors should be active and which should be inactive. The data aggregator may further determine receive communications from the QoE monitors comprising QoE data. The data aggregator may further aggregate the QoE data that is provided by the QoE monitors. The data aggregator may further use the aggregated QoE data to diagnose problems affecting the QoE environment.

In certain embodiments, the data aggregator maintains a QoE environment identifier group may include adding a QoE monitor to a QoE environment identifier group when the QoE monitor connects to a network ID associated with the QoE environment. In certain embodiments, the data aggregator maintains a QoE environment identifier group may include removing a QoE monitor from a QoE environment identifier group when that QoE monitor disconnects from a network ID associated with the QoE environment. In certain embodiments, the data aggregator maintains a QoE environment identifier group may include updating the QoE environment identifier group with data on which QoE monitors within a QoE environment identifier group are active and inactive.

In certain embodiments, the data aggregator determines which QoE monitors should be active and which should be inactive may include activating a QoE monitor by sending an activation signal to the QoE monitor. In certain embodiments, the data aggregator determines which QoE monitors should be active and which should be inactive may include deactivating a QoE monitor by sending an inactivation signal to the QoE monitor. In certain embodiments, the data aggregator determines which QoE monitors should be active and which should be inactive may include evaluating how many QoE monitors can remain active based on QoE environment parameters selected from the group consisting of a bandwidth cap, battery life, location, software version, monitor app version, operating system version, hardware model, and reliability. In certain embodiments, the data aggregator determines which QoE monitors should be active and which should be inactive may include evaluating the fitness of a monitor for activation based on QoE monitor parameters such as battery life, location within the QoE environment, data collection history, software version, monitor app version, operating system version, hardware model, and reliability. In certain embodiments, the data aggregator determines which QoE monitors should be active and which should be inactive may include evaluating the load on the WiFi bandwidth for that QoE environment and dynamically adjusting the bandwidth cap for QoE monitoring.

In certain embodiments, the data aggregator receives communications from QoE monitors may include receiving network ID information from a QoE monitor and determining whether it is associated with a QoE environment identifier. In certain embodiments, the data aggregator receives communications from QoE monitors further may include determining that the QoE monitor should be added to a QoE environment identifier group. In certain embodiments, the data aggregator receives communications from QoE monitors further may include determining that the QoE monitor should be removed from a QoE environment identifier group. In certain embodiments, the data aggregator receives communications from QoE monitors may include receiving and processing a request to join a QoE environment identifier group. In certain embodiments, the data aggregator receives communications from QoE monitors may include processing a request to be removed from a QoE environment identifier group. In certain embodiments, the data aggregator receives communications from QoE monitors may include processing a request for activation. In certain embodiments, the data aggregator receives communications from QoE monitors may include processing a request for inactivation. In certain embodiments, the data aggregator receives communications from QoE monitors may include receiving QoE data collected by the QoE monitor.

In certain embodiments, the data aggregator aggregates QoE data that is provided by the QoE monitors may include recording and/or comparing QoE data collected by the QoE monitors in a QoE environment identifier group to determine a mean value for a QoE parameter for that QoE environment identifier group. In certain embodiments, the data aggregator aggregates QoE data that is provided by the QoE monitors may include recording and/or comparing QoE data collected by the QoE monitors in a QoE environment identifier group to determine an outlier QoE Monitor. In certain embodiments, the data aggregator aggregates QoE data that is provided by the QoE monitors 204 may include recording and/or comparing QoE data collected by the QoE monitors in a QoE environment identifier group to determine locations within the QoE environment where outlier data is present. In certain embodiments, the data aggregator aggregates the QoE data that is provided by the QoE monitors may include recording and/or comparing QoE data collected by the QoE monitors in a QoE environment identifier group to determine the relative performance of a QoE monitor in comparison to others in the identifier group. In certain embodiments, the data aggregator aggregates the QoE data that is provided by the QoE monitors may include recording and/or comparing QoE data collected by the QoE monitors with the location of the QoE environment. In certain embodiments, the data aggregator aggregates the QoE data that is provided by the QoE monitors may include recording and/or comparing QoE data collected by the QoE monitors with environmental factors present at the QoE environment. In certain embodiments, the data aggregator aggregates the QoE data that is provided by the QoE monitors may include recording and/or comparing QoE data collected by the QoE monitors with a satellite providing connectivity to the QoE environment.

In an embodiment, a method for collecting and providing QoE data may include continually monitoring a network connection to determine a network ID and whether the network ID is associated with a QoE environment; and when the network ID is associated with the QoE environment, communicating an entry into the QoE environment to a data aggregator for the QoE environment, activating the gathering of QoE data, communicating the QoE data to the data aggregator, and stopping the gathering and communication of QoE data when the network ID no longer matches a QoE environment identifier or when designated as inactive.

In certain embodiments the method may further include periodically communicating with the data aggregator regardless of whether the network ID is associated with a QoE environment. In certain embodiments, the continually monitoring the network connection may include looking up the network ID on a look-up table to determine whether it is associated with a QoE environment identifier. In certain embodiments, the continually monitoring the network connection may include sending a query to a data aggregator or controller to determine whether the network ID is associated with a QoE environment identifier. In certain embodiments, the continually monitoring the network connection may include using a machine learning or statistical correlation model to determine the QoE environment identifier associated with the network ID.

In certain embodiments, the using a machine learning or statistical correlation model to determine the QoE environment identifier may include communicating with operator systems to obtain departure time and location. In certain embodiments, the using a machine learning or statistical correlation model to determine the QoE environment identifier may include communicating with operator systems to obtain the time and location during transportation. In certain embodiments, the using a machine learning or statistical correlation model to determine the QoE environment identifier may include communicating with operator systems to obtain the time and location at arrival. In certain embodiments, the using a machine learning or statistical correlation model to determine the QoE environment identifier may include communicating with vendor systems to obtain the time and location at departure. In certain embodiments, the using a machine learning or statistical correlation model to determine the QoE environment identifier may include communicating with vendor systems to obtain the time and location at during transportation. In certain embodiments, the using a machine learning or statistical correlation model to determine the QoE environment identifier may include communicating with vendor systems to obtain the time and location at arrival. In certain embodiments, the using a machine learning or statistical correlation model to determine the QoE environment identifier may include communicating with QoE monitors to obtain the time and location at departure. In certain embodiments, the using a machine learning or statistical correlation model to determine the QoE environment identifier may include communicating with QoE monitors to obtain the time and location during transportation. In certain embodiments, the using a machine learning or statistical correlation model to determine the QoE environment identifier may include communicating with QoE monitors to obtain the time and location at arrival. In certain embodiments, the using a machine learning or statistical correlation model to determine the QoE environment identifier may include obtaining a list of potential QoE identifiers. In certain embodiments, the using a machine learning or statistical correlation model to determine the QoE environment identifier may include selecting a probable QoE identifier from the list of potential QoE identifiers. In certain embodiments, the selecting a probable QoE identifier may include generating confidence scores for the potential QoE identifiers. In certain embodiments, the selecting a probable QoE identifier may include evaluating the confidence scores of the potential QoE identifiers. In certain embodiments, the using a machine learning or statistical correlation model to determine the QoE environment identifier may include calculating and assigning a confidence score to one or more of the potential QoE identifiers. In certain embodiments, the calculating and assigning a confidence score may include considering the time and location data at departure. In certain embodiments, the calculating and assigning a confidence score may include considering the time and location data at arrival. In certain embodiments, the calculating and assigning a confidence score may include considering the time and location data during transportation. In certain embodiments, the calculating and assigning a confidence score may include reevaluating and updating the confidence score during transportation based on the time and location data during transportation. In certain embodiments, the calculating and assigning a confidence score may include reevaluating and updating the confidence score during transportation based on the correlation of an observed travel path in comparison to an expected travel path for a potential QoE identifier. In certain embodiments, the calculating and assigning a confidence score may include reevaluating and updating the probable QoE identifier based on the analysis of data gathered after departure. In certain embodiments, the using a machine learning or statistical correlation model to determine the QoE environment identifier may include using time and location data at departure to determine the QoE identifier. In certain embodiments, the using a machine learning or statistical correlation model to determine the QoE environment identifier may include using time and location data during transportation to compare an actual travel path to an expected travel path. In certain embodiments, the using a machine learning or statistical correlation model to determine the QoE environment identifier may include using time and location data at arrival to determine the QoE identifier.

In certain embodiments, the stopping the gathering and communication of QoE data may include receiving an instruction from the data aggregator to become an inactive agent. In certain embodiments, the stopping the gathering and communication of QoE data may include sending a message to the data aggregator to remove the QoE monitor from a QoE environment identifier group.

In certain embodiments, the communicating an entry into the QoE environment to a data aggregator may include communicating a request to join a QoE environment identifier group to the data aggregator. In certain embodiments, the communicating an entry into the QoE environment to a data aggregator may include sending a request to the data aggregator to become active, and waiting for a confirmation before activating the gathering of QoE data.,

In certain embodiments, the activating the gathering of QoE data may include gathering QoE data for the data aggregator. In certain embodiments, the gathering QoE data for the data aggregator may include running QoE data tests.

In certain embodiments, the communicating the QoE data to the data aggregator may include communicating test results to the data aggregator. In certain embodiments, the communicating the QoE data to the data aggregator may include communicating updated QoE monitor parameters to the data aggregator. In certain embodiments, the QoE monitor parameters comprise a first parameter selected from the group consisting of battery life, location, software version, monitor app version, operating system version, and hardware model.

In an embodiment, a method for aggregating QoE data may include maintaining a QoE environment identifier group comprising a list of QoE monitors that are located within that a QoE environment, determining which QoE monitors should be active and which should be inactive, receiving communications from QoE monitors, aggregating the QoE data that is provided by the QoE monitors; and using the aggregated QoE data to diagnose problems affecting the QoE environment.

In certain embodiments, the maintaining a QoE environment identifier group may include adding a first QoE monitor to the QoE monitor identifier group when the first QoE monitor connects to a network ID associated with the QoE environment. In certain embodiments, the maintaining a QoE environment identifier group may include removing a first QoE monitor from the QoE environment identifier group when the first QoE monitor disconnects from a network associated with the QoE environment. In certain embodiments, the maintaining a QoE environment identifier group may include updating the QoE identifier group with data on which QoE monitors within a QoE environment identifier group are active and inactive.

In certain embodiments the determining which QoE monitors should be active and which should be inactive may include activating a first QoE monitor by sending an activation signal to the first QoE monitor. In certain embodiments, the determining which QoE monitors should be active and which should be inactive may include deactivating a first QoE monitor by sending an inactivation signal to the first QoE monitor. In certain embodiments, the determining which QoE monitors should be active and which should be inactive may include evaluating how many QoE monitors can remain active based on a QoE environment parameter selected from the group consisting of a bandwidth cap, battery life, location, software version, monitor app version, operating system version, hardware model, and reliability. In certain embodiments, the determining which QoE monitors should be active and which should be inactive may include evaluating the fitness of a monitor for activation based on QoE monitor parameters such as battery life, location within the QoE environment, data collection history, software version, monitor app version, operating system version, hardware model, and reliability. In certain embodiments, the determining which QoE monitors should be active and which should be inactive may include evaluating the load on the WiFi bandwidth for that QoE environment and dynamically adjusting the bandwidth cap for QoE monitoring.

In certain embodiments, the receiving communications from QoE monitors may include receiving network ID information from a QoE monitor and determining whether it is associated with a QoE environment identifier. In certain embodiments, the receiving communications from QoE monitors may include determining that a first QoE monitor should be added to a QoE environment identifier group. In certain embodiments, the receiving communications from QoE monitors may include determining that a first QoE monitor should be removed from a QoE environment identifier group. In certain embodiments, the receiving communications from QoE monitors may include receiving and processing a request to join a QoE environment identifier group. In certain embodiments, the receiving communications from QoE monitors may include processing a request to be removed from a QoE environment identifier group. In certain embodiments, the receiving communications from QoE monitors may include processing a request for activation. In certain embodiments, the receiving communications from QoE monitors may include processing a request for inactivation. In certain embodiments, the receiving communications from QoE monitors may include receiving QoE data collected by the QoE monitor.

In certain embodiments the aggregating QoE data that is provided by the QoE monitors may include recording and/or comparing QoE data collected by the QoE monitors in a QoE environment identifier group to determine a mean value for a QoE parameter for that QoE environment identifier group. In certain embodiments, the aggregating QoE data that is provided by the QoE monitors may include recording and/or comparing QoE data collected by the QoE monitors in a QoE environment identifier group to determine an outlier QoE Monitor. In certain embodiments, the aggregating QoE data that is provided by the QoE monitors may include recording and/or comparing QoE data collected by the QoE monitors in a QoE environment identifier group to determine locations within the QoE environment where outlier data is present. In certain embodiments, the aggregating QoE data that is provided by the QoE monitors may include recording and/or comparing QoE data collected by the QoE monitors in a QoE environment identifier group to determine the relative performance of a QoE monitor in comparison to others in the identifier group. In certain embodiments, the aggregating QoE data that is provided by the QoE monitors may include recording and/or comparing QoE data collected by the QoE monitors with the location of the QoE environment. In certain embodiments, the aggregating QoE data that is provided by the QoE monitors may include recording and/or comparing QoE data collected by the QoE monitors with environmental factors present at the QoE environment. In certain embodiments, the aggregating QoE data that is provided by the QoE monitors may include recording and/or comparing QoE data collected by the QoE monitors with a satellite providing connectivity to the QoE environment.

In an embodiment, a method for determining a network ID to QoE Identifier mapping may include: obtaining a network ID from one or more QoE monitors; obtaining a departure data set from the one or more QoE monitors, the departure data set comprising a time of departure and a GPS location at departure; obtaining a list of potential QoE identifiers based on the departure data set; and generating a confidence score for a first QoE identifier of the list of potential QoE identifiers.

In certain embodiments, the obtaining a list of potential QoE identifiers based on the departure data set may include submitting a query to operator systems to obtain a list of potential QoE identifiers having similar departure times and locations. In certain embodiments, the obtaining a list of potential QoE identifiers based on the departure data set may include submitting a query to vendor systems to obtain a list of potential QoE identifiers having similar departure times and locations. In certain embodiments, the obtaining a list of potential QoE identifiers based on the departure data set may include submitting a query to one or more public databases to obtain a list of potential QoE identifiers having similar departure times and locations. \

In certain embodiments, the method may further include: obtaining one or more travel data sets from the one or more QoE monitors; and updating the confidence score for the first QoE identifier based on a comparison of the travel data sets with an expected travel path for the first QoE identifier. In certain embodiments, the updating the confidence score for the first QoE identifier may include communicating with operator systems to obtain arrival time and location information, and estimating an expected travel path for the first QoE identifier for use in the comparison with the travel data sets. In certain embodiments, the updating the confidence score for the first QoE identifier may include communicating with vendor systems to obtain arrival time and location information, and estimating an expected travel path for the first QoE identifier for use in the comparison with the travel data sets. In certain embodiments, the updating the confidence score for the first QoE identifier may include querying public databases to obtain arrival time and location information, and estimating an expected travel path for the first QoE identifier for use in the comparison with the travel data sets. In certain embodiments, the updating the confidence score for the first QoE identifier may include communicating with operator systems to obtain travel path information for the first QoE identifier for use in the comparison with the travel data sets. In certain embodiments, the updating the confidence score for the first QoE identifier may include communicating with vendor systems to obtain travel path information for the first QoE identifier for use in the comparison with the travel data sets. In certain embodiments, the updating the confidence score for the first QoE identifier may include querying public databases to obtain travel path information for the first QoE identifier for use in the comparison with the travel data sets. In certain embodiments, the updating the confidence score for the first QoE identifier may include communicating with operator systems to obtain time and location during transportation. In certain embodiments, the updating the confidence score for the first QoE identifier may include communicating with vendor systems to obtain to obtain time and location during transportation. In certain embodiments, the updating the confidence score for the first QoE identifier may include querying public databases to obtain expected time and location during transportation.

In certain embodiments, the method may further include: obtaining one or more arrival data sets from the one or more QoE monitors; and updating the confidence score for the first QoE identifier based on a comparison of the arrival data sets with an expected arrival data the first QoE identifier. In certain embodiments, the updating the confidence score for the first QoE identifier based on a comparison of the arrival data sets with an expected arrival data the first QoE identifier may include communicating with operator systems to obtain the time and location at arrival. In certain embodiments, the updating the confidence score for the first QoE identifier based on a comparison of the arrival data sets with an expected arrival data the first QoE identifier may include communicating with vendor systems to obtain the time and location at arrival. In certain embodiments, the updating the confidence score for the first QoE identifier based on a comparison of the arrival data sets with an expected arrival data the first QoE identifier may include querying public databases to obtain the expected time and location at arrival.

The disclosed concepts utilize the smart devices carried by the employees of the site operator to run a QoE software agent in a zero-touch manner that is invisible to the employees and does not require their input or participation or interfere with their duties.

A QoE software agent may be installed on one or more employee devices that are carried or utilized in an operating environment, and may run in active or sleeping mode. The QoE software agent may monitor the WiFi access point that its host mobile device is connected to in order to determine when it has entered a QoE operating environment, and to determine its network ID, such as the basic service set identifier (BSSID) of the QoE operating environment. It may further compare its current network ID| to a pre-configured network-ID-to-operating environment identifier table listing the network IDs available on each operating environment (airplane, ship, train, truck, bus, oil rig, etc) to be monitored. This table may be preconfigured on the QoE software agent, or it may be accessed by the software agent via a network connection to a database or server that can provide such a table.

It is industry practice to assign one or more unique network ID (such as a BSSIDs) to each WiFi access point, often assigned during manufacturing or derived from another unique identifier such as a serial number. A WiFi access point broadcasts its network ID to other devices for use when connecting to the access point, and the current connected network ID is available to the QoE software agent. The network-ID-to-operating environment identifier table can be used to determine the operating environment identifier (such as an aircraft tail number, vehicle identification number, or other such unique identifier for an environment) that is associated with a network ID. If no operating environment identifier is found, then the WiFi access point is not within an QoE operating environment, and the QoE software agent can sleep until the network ID for the host device changes.

The QoE software agent may automatically begin collecting QoE data (such as ping/latency, upload or download speeds, connection quality, interference, error rate), including running QoE data tests (such as initiating a large upload or download, or pinging a series of websites, simulating the demands of video streaming services, or any other QoE data test known in the art or to be developed) when it detects a network ID matching the network-ID-to-vehicle table, and may stop collecting data when its WiFi disconnects or when it obtains a new network ID which no longer matches an operating environment identifier on the table. Data collection starts and stops automatically with no user interaction required, improving QoE software agent reliability. Collected QoE data will be tagged with the vehicle ID found in the table to associate the collected data with a specific vehicle for subsequent analysis.

The system may further learn the network-ID-to-vehicle mapping through a human-assisted, machine learning, or statistical model (or a combination of the same) that may detects a flight's departing airport location and/or gate information, a flight's arriving airport location and/or gate information, and associates those locations to the appropriate airport codes, and correlates the flight time and aircraft operator to a flight number and an aircraft tail number. This may be done when a network-ID-to-vehicle table is not available from the operator, or as part of a fail-safe or error checking process. When the QoE software agent detects the network ID and forwards the information to a QoE server, the server can determine if the network ID has a known mapping to an aircraft tail. The QoE server may perform an error check by verifying the departing airport location and the arriving airport location to detect errors or changes in the network ID configuration, which may be due to equipment changes on the aircraft. Additionally, the QoE server may measure the usage of network ID to determine when a network ID is failed or about to fail.

A machine learning model may be implemented on the QoE server to make such determinations. It may communicate with onboard systems, and/or QoE software agents in order to determine locations at takeoff, landing and during flight. For example, in such a system implemented for passenger airlines, the model may detect GPS location and time data at takeoff, and use the GPS location data and publicly available databases or third-party services (such as flight logging or scheduling information services) to determine an airport code and/or gate number at which the airplane is located. Such public databases/third party services may allow the model to obtain a list of potential airplanes that may host the network ID. That list can be narrowed based on the GPS location (i.e. if a gate number or carrier can be determined based on the GPS location within the airport). The model may assign a confidence score to one or more (or all) of the potential tail-numbers that may be present at that airport. As the flight takes off, the model may obtain and use location data while in-flight, and reevaluate its confidence score for one or more (or all) of the potential tail-numbers/airplanes via a statistical correlation of observed location data (i.e. the observed flight path) vs the expected flight path of the airplanes on the potential tail-number list. The model may create new mappings and ask for human input as to tail number if the information from the public databases and/or third-party platforms is insufficient to identify a tail number given the observed location and time data. A final check or confirmation may be made at the time of landing to confirm that the expected destination airport and/or gate matches the selected tail-number. Such a system can be set up to interface with operator and/or vendor systems though APIs to get direct information on time and location rather than using QoE software agents on crew devices. Such a system can also be used to error check and/or to validate data before reporting it. Such a machine learning system can also be implemented to detect and identify trends, and to identify potential sources of errors when measurements fall off from the expected trendlines (which may indicate that equipment is nearing the point of failure).

When multiple QoE software agents match the same operating environment identifier simultaneously, such as when multiple employees with QoE software agents on their smart devices enter a QoE environment, a controller may designate one, or a subset, of those QoE software agents as active agents, and designate the other agents as inactive agents. The active agents may then monitor QoE variables and/or run QoE tests while the inactive agents do nothing in order to conserve bandwidth. Active agents may be selected using criteria that may include but is not limited to, remaining battery level, hardware model, device CPU load, history of outlier QoE data (which may indicate potential hardware failure on the host device), prior performance scores, location within the operating environment, etc. to improve the reliability of QoE measurements. Analyzing and correlating QoE data across multiple active agents in the same operating environment can indicate whether network issues are isolated to a particular WiFi access point (local WiFi congestion, WiFi access point hardware failure, etc) or are occurring on a shared internet uplink (when all QoE software agents running a particular test observe the same QoE change), or environmental factors within the QoE operating environment.

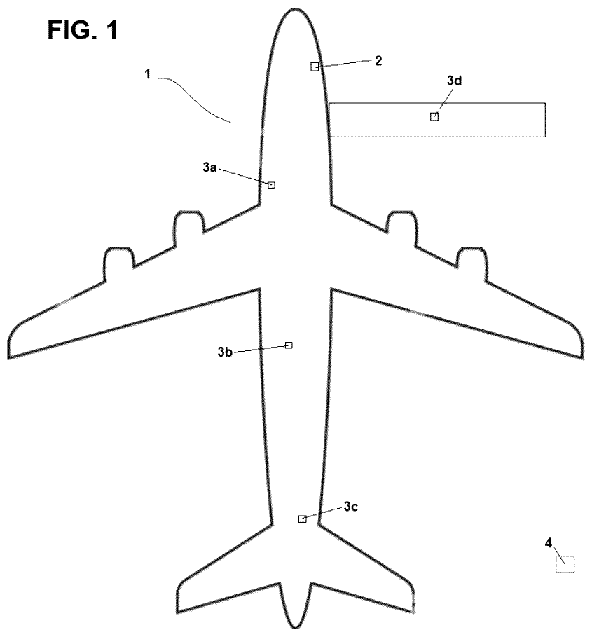

FIG. 1 illustrates an exemplary QoE operating environment 1, in a passenger airplane, providing WiFi internet access to its passengers through one or more wireless routers and optionally one or more repeaters (not shown). Though the exemplary embodiment is a passenger airplane, the disclosed concepts can be practiced with any of the QoE environments described above. The operating environment may be provided with a computing device operating as a controller 2 to monitor and aggregate QoE data, and to coordinate which QoE monitors 3 should be active and which should be inactive The operating environment 1 may further be provided with one or more QoE monitors 3, 3a, 3b, 3c, 3d, which may be employee-carried smart devices, such as iOS and Android devices or smartphones, which may have a QoE software agent installed on them to allow them to interface with the controller and gather and communicate QoE data.

During operation, as the QoE monitors enter the QoE operating environment 1, they may connect to the WiFi provided by the QoE operating environment 1. This connection may be preconfigured to occur automatically once the QoE monitor enters the range of the QoE environment or can be manually engaged by the employee. As shown in FIG. 1, some QoE monitors 3a, 3b, 3c may be within the operating environment, while others may be outside of the QoE operating environment, such as QoE monitor 3d. The QoE monitors 3a, 3b, 3c in the QoE environment 1, may be connected to the environment's WiFi. Upon connecting to the QoE environment's WiFi, such QoE monitors 3a, 3b, 3c may automatically detect the network ID of the QoE environment 1, and may automatically look up and determine the QoE environment identifier (in this case the airplane's tail number) associated with that QoE environment 1. As discussed above, the QoE environment identifier may be obtained from a look-up table, database query or other such request to obtain the QoE environment identifier associated with the network IDs. This look-up or query may be performed on the device or through the wireless connection to the Controller or a database available on the network. As each of the QoE monitors enters the operating environment and determines the network ID they may communicate with the controller—either to notify the controller that they have connected to the QoE environment, or as part of reporting gathered QoE data. The controller may then determine whether that QoE monitor 3 should be (or remain) active, or whether they should be (or remain) inactive, and may communicate that decision back to the QoE monitor 3. Persons of skill in the art will recognize that a system may be implemented such that QoE monitors 3 begin active unless instructed by a controller 2 to be inactive, or begin inactive until a controller 2 or data aggregator 4 instructs them to activate, depending on the needs of the system being implemented. In the exemplary embodiment shown in FIG. 1, QoE Monitors 3a and 3c may be active, QoE monitor 3b may be inactive, and QoE monitor 3D may not be connected to QoE environment's 1 WiFi because it is not yet within the environment.

Once a QoE monitor 3a, 3c is connected to the QoE environment's 1 WiFi, and is active, it may begin gathering QoE data and transmitting same to the controller 2 or data aggregator or other computing device serving as a data aggregator. The data aggregator 4 may or may not be located within the QoE environment 1, depending on the needs of the implemented system. A QoE monitor 3 may gather a variety of QoE data, including but not limited to ping or latency, upload or download speeds, connection quality, interference, error rate or packet loss rates, and other QoE data known in the art or to be developed, and may further run QoE data tests (such as initiating a large upload or download, or pinging a series of websites, simulating streaming service demands, or any other QoE data test known in the art or to be developed) location (within the QoE environment). The QoE monitor may then communicate the data that is gathered to the controller 2 and/or data aggregator for evaluation.

In some systems, a data aggregator 4, which may be onsite as controller 2 or separate, or which may be offsite, may be utilized. In embodiments with an off-site data aggregator, the controller may be in communication with the data aggregator. The data aggregator 4 may be provided with a network ID to QoE environment identifier table to use in response to a QoE monitor 3 requests for same. The table may be predetermined with the network-ID-to-QoE-environment identifier (for example a list of tail numbers for a fleet of airplanes and the network ID(s) associated with each tail number). The table may periodically update the table at predefined intervals or when an update is pushed onto it. The mapping of the network ID to a QoE identifier may be accomplished through: (1) hard mapping via a table that is provided by the operator (for example an airline) or vendor that provides such data; (2) learning the network ID to QoE identifier through data collection and correlation to the QoE Identifier data (for example a flight tail number and its expected flight path) using (a) a machine learning process, (b) human analysis of data collected (before the network ID to QoE identifier table entry exists for that network ID, or (c) a combination of (a) and (b). These methods may further be used to detect changes or errors in the Network ID to QoE identifier table (such as when a plane is repurposed to a different flight path before that information is propagated to the available tables).

For example, the data aggregator 4 may implement a machine-learning or statistical correlation model to make a determination of Network ID-to-QoE environment identifier. Such a model may be implemented to communicate with onboard QoE environment systems, and/or QoE monitors 3 in order to determine locations at key moments, such as departure, arrival and during transportation. For example, in such a system implemented for passenger airlines, the model may obtain observed GPS location and time data at takeoff from one or more QoE monitors. It may correlate that GPS location data using operator supplied information, publicly available databases and/or or third-party services (such as flight logging or scheduling information services) to determine an airport code and/or gate number at which the airplane is located. Such public databases/third party services may allow the model to obtain a list of potential airplanes that may host the network ID. The model may narrow or weigh the members of that list based on the GPS location (i.e. if a gate number or carrier can be determined based on the GPS location within the airport). The model may further assign a confidence score to one or more (or all) of the potential tail-numbers that may be present at that airport based on the time and location data. As the flight takes off, the model may obtain and use location data while in-flight, and reevaluate its confidence score for one or more (or all) of the potential tail-numbers/airplanes via a statistical correlation of observed location data (i.e. the observed flight path) vs the expected flight path of the airplanes on the potential tail-number list. The model may create new mappings and ask for human input as to tail number if the information from the public databases and/or third-party platforms is insufficient to identify a tail number given the observed location and time data. A final check or confirmation may be made at the time of landing to confirm that the expected destination airport and/or gate matches the selected tail-number. Such a system can be set up to interface with operator and/or vendor systems though APIs to get direct information on time and location rather than using QoE monitors 3 on crew devices. Such a system can also be used to error check and/or to validate data before reporting it. Such a machine learning system can also be implemented to detect and identify trends, and to identify potential sources of errors when measurements fall off from the expected trendlines (which may indicate that equipment is nearing the point of failure). For example, by evaluating data provided from multiple QoE monitors 3 a machine learning model on the data aggregator 4 may detect a pattern of performance or traffic distribution anomalies relating to a network ID/access point, that may indicate that it is failing or has failed, and flag that network ID to system operators for evaluation and/or maintenance.

The data aggregator 4 may bifurcate the client ID for different communications. For example when communicating with the client and/or the client's systems or tracking client sessions internally, the data aggregator 4 may use the client-supplied client ID (unique per client). When communicating with the back end systems, the data aggregator 4 may use a synthesized client ID that includes a QoE Environment identifier for faster data processing.

The data aggregator 4 may receive periodic communications from the QoE monitors identifying the network ID that to which the QoE monitor is connected. The data aggregator may maintain a list of QoE environment identifier groups representing the QoE monitors connected to each such QoE environment. This may include which QoE monitors 3 are active and which are inactive. The data aggregator may add or remove a QoE monitor 3 from a QoE environment identifier group based on the communication of network ID information from the QoE monitors 3, or may receive requests from the QoE monitors. Similarly, the data aggregator directly or through the controller 2, may send instructions to the QoE monitors 3 to activate or inactivate them.

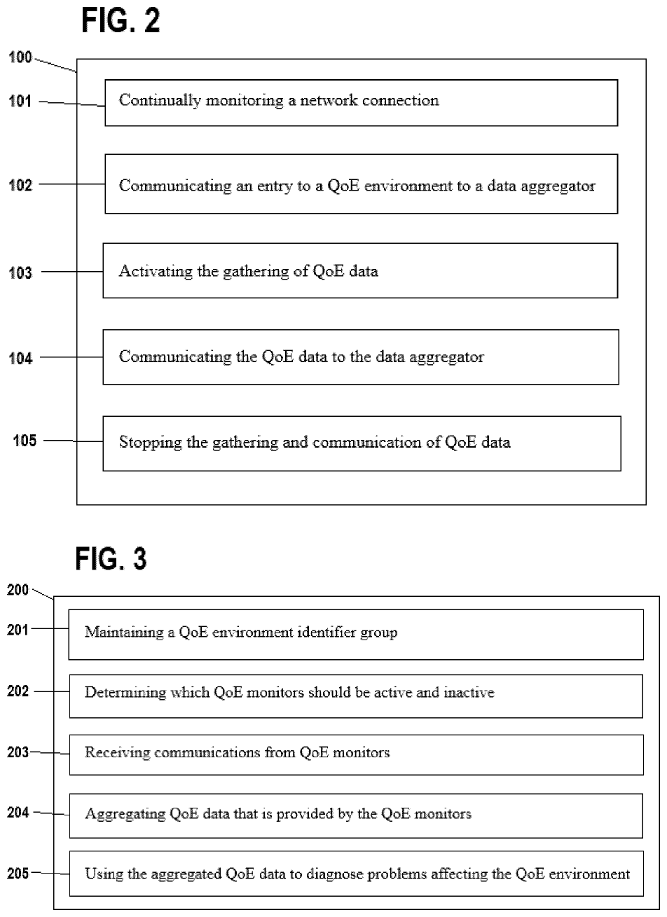

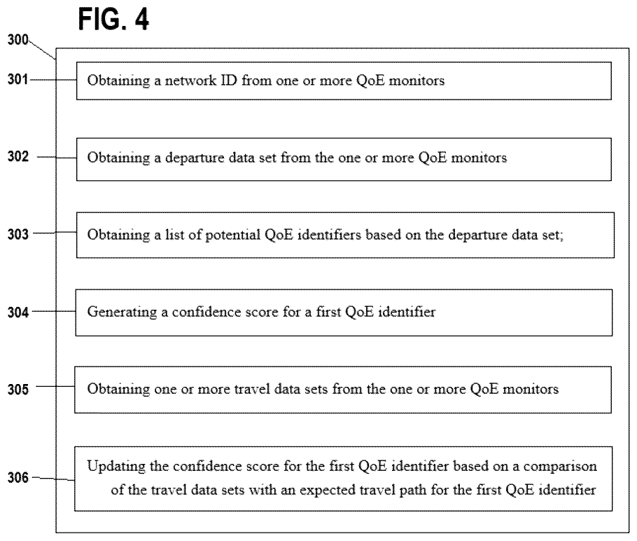

FIG. 2 illustrates a method for providing QoE data 100 that may run on a QoE Monitor, that may include: continually monitoring a network connection 101 to determine its network ID and whether that network ID is associated with a QoE environment; communicating an entry to a QoE environment to a data aggregator 102 (such as controller 2 in the QoE environment or an offsite server) when the network ID is associated with a QoE environment; activating the gathering of QoE data 103; communicating the QoE data to the data aggregator 104; and stopping the gathering and communication of QoE data 105 when the network ID no longer matches a QoE environment identifier or when designated as inactive.

Continually monitoring a network connection 101 may further include looking up the network ID on a look-up table to determine whether it is associated with a QoE environment identifier. Continually monitoring a network connection 101 may further include sending a query to a data aggregator or controller 2 to determine whether the network ID is associated with a QoE environment identifier. Continually monitoring a network connection 101 may further include using a machine learning or statistical correlation model to determine the QoE environment identifier associated with the network ID.

The using a machine learning or statistical correlation model to determine the QoE environment identifier may include communicating with operator systems to obtain departure time and location. The using a machine learning or statistical correlation model to determine the QoE environment identifier may include communicating with operator systems to obtain the time and location during transportation. The using a machine learning or statistical correlation model to determine the QoE environment identifier may include communicating with operator systems to obtain the time and location at arrival. The using a machine learning or statistical correlation model to determine the QoE environment identifier may include communicating with vendor systems to obtain the time and location at departure. The using a machine learning or statistical correlation model to determine the QoE environment identifier may include communicating with vendor systems to obtain the time and location at during transportation. The using a machine learning or statistical correlation model to determine the QoE environment identifier may include communicating with vendor systems to obtain the time and location at arrival. The using a machine learning or statistical correlation model to determine the QoE environment identifier may include communicating with QoE monitors to obtain the time and location at departure. The using a machine learning or statistical correlation model to determine the QoE environment identifier may include communicating with QoE monitors to obtain the time and location during transportation. The using a machine learning or statistical correlation model to determine the QoE environment identifier may include communicating with QoE monitors to obtain the time and location at arrival.

The using a machine learning or statistical correlation model to determine the QoE environment identifier may include selecting a probable QoE identifier from the list of potential QoE identifiers. The selecting a probable QoE identifier may include evaluating the confidence scores of the potential QoE identifiers. The using a machine learning or statistical correlation model to determine the QoE environment identifier may include obtaining a list of potential QoE identifiers. The using a machine learning or statistical correlation model to determine the QoE environment identifier may include calculating and assigning a confidence score to one or more of the potential QoE identifiers. The calculating and assigning a confidence score may include considering the time and location data at departure. The calculating and assigning a confidence score may include considering the time and location data at arrival. The calculating and assigning a confidence score may include considering the time and location data during transportation. The calculating and assigning a confidence score may include reevaluating and updating the confidence score during transportation based on the time and location data during transportation. The calculating and assigning a confidence score may include reevaluating and updating the confidence score during transportation based on the correlation of an observed travel path in comparison to an expected travel path for a potential QoE identifier. The calculating and assigning a confidence score may include reevaluating and updating the probable QoE identifier based on the analysis of data gathered after departure.

The using a machine learning or statistical correlation model to determine the QoE environment identifier may include using time and location data at departure to determine the QoE identifier. The using a machine learning or statistical correlation model to determine the QoE environment identifier may include using time and location data during transportation to compare an actual travel path to an expected travel path. The using a machine learning or statistical correlation model to determine the QoE environment identifier may include using time and location data at departure to determine the QoE identifier.

Activating the gathering of QoE data 103 may include communicating a request to join a QoE environment identifier group to the data aggregator. Activating the gathering of QoE data 103 may include sending a request to the data aggregator to become an active agent, and waiting for a confirmation before beginning to collect QoE data. Activating the gathering of QoE data 103 may include gathering QoE data for the data aggregator. Gathering QoE data for the data aggregator may include running QoE data tests.

Communicating the QoE data to the data aggregator 104 may include communicating test results to the data aggregator. Communicating the QoE data to the data aggregator 104 may include communicating updated QoE monitor parameters, such as current battery life, location, software version, monitor app version, operating system version, and hardware model.

Stopping the gathering and communication of QoE data 105 may include receiving an instruction from a data aggregator to become an inactive agent. Stopping the gathering and communication of QoE data 105 may include sending a message to the data aggregator to remove the QoE Monitor 3 from the QoE Environment identifier group.

FIG. 3 illustrates a method for aggregating QoE data 200 that may run on a data aggregator that may include: maintaining a QoE environment identifier group 201; comprising a list of QoE monitors that are located within that respective QoE environment; determining which QoE monitors should be active and which should be inactive 202; receiving communications from QoE monitors 203; aggregating QoE data that is provided by the QoE monitors 204 and using the aggregated QoE data to diagnose problems affecting the QoE data 205.

Maintaining a QoE environment identifier group 201 may include adding a QoE monitor to a QoE monitor identifier group when the QoE monitor connects to the QoE environment's WiFi. Maintaining a list of QoE environment identifier groups 201 may include removing a QoE monitor from a QoE environment identifier group when that QoE monitor disconnects from the QoE environment's WiFi. Maintaining a list of QoE environment identifier groups 201 may include which QoE monitors within a QoE environment identifier group are active and inactive.

Determining which QoE monitors should be active and which should be inactive 202 may include activating a QoE monitor by sending an activation signal to the QoE monitor. Determining which QoE monitors should be active and which should be inactive 202 may include deactivating a QoE monitor by sending an inactivation signal to the QoE monitor. Determining which QoE monitors should be active and which should be inactive 202 may include evaluating how many QoE monitors can remain active based on QoE environment parameters, such as a bandwidth cap, battery life, software version, monitor app version, operating system version, hardware model, and reliability. Determining which QoE monitors should be active and which should be inactive 202 may include evaluating the fitness of a monitor for activation based on QoE monitor parameters such as battery life, location within the QoE environment, data collection history, software version, monitor app version, operating system version, hardware model, and reliability. Determining which QoE monitors should be active and which should be inactive 202 may include evaluating the load on the WiFi bandwidth for that QoE environment and dynamically adjusting the bandwidth cap for QoE monitoring.

Receiving communications from QoE monitors 203 may include receiving network ID information from a QoE monitor and determining whether it is associated with a QoE environment identifier. Receiving communications from QoE monitors 203 may further include determining that the QoE monitor should be added to a QoE environment identifier group. Receiving communications from QoE monitors 203 may further include determining that the QoE monitor should be removed from a QoE environment identifier group. Receiving communications from QoE monitors 203 may include receiving and processing a request to join a QoE environment identifier group. Receiving communications from QoE monitors 203 may include processing a request to be removed from a QoE environment identifier group. Receiving communications from QoE monitors 203 may include processing a request for activation. Receiving communications from QoE monitors 203 may include processing a request for inactivation. Receiving communications from QoE monitors 203 may include receiving QoE data collected by the QoE monitor.

Aggregating QoE data that is provided by the QoE monitors 204 may include recording and/or comparing QoE data collected by the QoE monitors in a QoE environment identifier group to determine a mean value for a QoE parameter for that QoE environment identifier group. Aggregating QoE data that is provided by the QoE monitors 204 may include recording and/or comparing QoE data collected by the QoE monitors in a QoE environment identifier group to determine an outlier QoE Monitor. Aggregating QoE data that is provided by the QoE monitors 204 may include recording and/or comparing QoE data collected by the QoE monitors in a QoE environment identifier group to determine locations within the QoE environment where outlier data is present. Aggregating QoE data that is provided by the QoE monitors 204 may include recording and/or comparing QoE data collected by the QoE monitors in a QoE environment identifier group to determine the relative performance of a QoE monitor in comparison to others in the identifier group. Aggregating QoE data that is provided by the QoE monitors 204 may include recording and/or comparing QoE data collected by the QoE monitors with the location of the QoE environment. Aggregating QoE data that is provided by the QoE monitors 204 may include recording and/or comparing QoE data collected by the QoE monitors with environmental factors present at the QoE environment. Aggregating QoE data that is provided by the QoE monitors 204 may include recording and/or comparing QoE data collected by the QoE monitors with a satellite providing connectivity to the QoE environment.

A system operating as described in the disclosed concepts can ensure that it operates within a predetermined bandwidth cap, providing a zero-touch user experience (such that employees don't need to coordinate among themselves who is running EQoE on each flight, and can carry on their duties without interruption), and increasing robustness through QoE monitor redundancy. The system can maintain consistent QoE data quality despite real-world client issues such as low battery, a QoE monitor device temporarily running CPU-intensive or network-intensive apps, a broken WiFi antenna, normal WiFi jitter, or localized wifi congestion on an aircraft, etc.

QoE Monitors may be selected for activation by selecting one or more devices from those that are in the QoE environment (for example, multiple crew members each have a device running that app) to optimize (a) accuracy of measurement, and (b) reduction of bandwidth consumed, in the aggregate, across multiple devices

### IV. Specifics of Learning Model

1) detecting flight egress/ingress location via GPS or other
2) associating the location (GPS) to an airport code
3) detecting location in flight (GPS or other)
4) associating all location measurements to the time-of-day and date
5) associating the aircraft operator (for example Delta) to the detected information
6) using that data to lookup flight information including tail number from a 3rd party flight information provider (for example flight aware)

### V. AP Health Tracking

1) a method for tracking BSSID/MAC AP usage and health, deviations from that baseline over time, and alerting when a BSSID/MAC is determined to be failed or about to fail

In some implementations a non-transitory, computer-readable medium may contain instructions that when executed by the processor cause the processor to perform any of the methods described herein.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed:

1. A system comprising:
a QoE environment comprising a data aggregator and one or more wireless routers; and
one or more QoE monitors, wherein the QoE monitors are capable of connecting to the environment's wireless router to communicate with the data aggregator;
wherein upon connecting to the QoE environment the QoE monitors obtain an active or inactive status, and if active automatically begin collecting and communicating QoE data to the data aggregator without user input.

2. The system of claim 1 further comprising a first QoE monitor of the one or more QoE monitors that:
continually monitors a network connection to determine a network ID and whether the network ID is associated with the QoE environment;
wherein when the network ID is associated with the QoE environment, the first QoE monitor communicates its entry into the QoE environment to the data aggregator for the QoE environment, and if designated as active:
activates the gathering of QoE data;
communicates the QoE data to the data aggregator; and
stops the gathering and communication of QoE data to the data aggregator when the first QoE monitor's network ID no longer matches the QoE environment identifier or when the first QoE monitor is designated as inactive.

3. The system of claim 2 wherein the first QoE monitor continually monitors a network connection comprises using a machine learning or statistical correlation model to determine the QoE environment identifier associated with the network ID.

4. The system of claim 3 wherein the using a machine learning or statistical correlation model to determine the QoE environment identifier comprises obtaining a list of potential QoE identifiers.

5. The system of claim 4 wherein the using a machine learning or statistical correlation model to determine the QoE environment identifier comprises selecting a probable QoE identifier from the list of potential QoE identifiers.

6. The system of claim 5 wherein the selecting a probable QoE identifier comprises generating confidence scores for the potential QoE identifiers.

7. The system of claim 6 wherein the selecting a probable QoE identifier comprises evaluating the confidence scores of the potential QoE identifiers.

8. The system of claim 7 wherein the using a machine learning or statistical correlation model to determine the QoE environment identifier comprises calculating and assigning a confidence score to one or more of the potential QoE identifiers.

9. The system of claim 8 wherein the calculating and assigning a confidence score comprises considering the time and location data at departure.

10. The system of claim 8 wherein the calculating and assigning a confidence score comprises considering the time and location data at arrival.

11. The system of claim 8 wherein the calculating and assigning a confidence score comprises reevaluating and updating the confidence score during transportation based on the time and location data during transportation.

12. The system of claim 8 wherein the calculating and assigning a confidence score comprises reevaluating and updating the confidence score during transportation based on the correlation of an observed travel path in comparison to an expected travel path for a potential QoE identifier.

13. The system of claim 2 wherein the first QoE monitor communicates the QoE data to the data aggregator comprises communicating updated QoE monitor parameters to the data aggregator.

14. The system of claim 13 wherein the QoE monitor parameters comprise a first parameter selected from the group consisting of battery life, location, software version, monitor app version, operating system version, and hardware model.

15. A method for collecting and providing QoE data comprising:
continually monitoring a network connection to determine a network ID and whether the network ID is associated with a QoE environment; and
when the network ID is associated with the QoE environment:
communicating an entry into the QoE environment to a data aggregator for the QoE environment,
activating the gathering of QoE data,
communicating the QoE data to the data aggregator, and
stopping the gathering and communication of QoE data when the network ID no longer matches a QoE environment identifier or when designated as inactive.

16. The method of claim 15 wherein the continually monitoring the network connection comprises using a machine learning or statistical correlation model to determine the QoE environment identifier associated with the network ID.

17. The method of claim 16 wherein the using a machine learning or statistical correlation model to determine the QoE environment identifier comprises communicating with QoE monitors to obtain the time and location at arrival.

18. The method of claim 17 wherein the using a machine learning or statistical correlation model to determine the QoE environment identifier comprises calculating and assigning a confidence score to one or more of the potential QoE identifiers.

19. The method of claim 18 wherein the calculating and assigning a confidence score comprises reevaluating and updating the confidence score during transportation based on the time and location data during transportation.

20. The method of claim 18 wherein the calculating and assigning a confidence score comprises reevaluating and updating the confidence score during transportation based on the correlation of an observed travel path in comparison to an expected travel path for a potential QoE identifier.
